(19) United States
(12) Patent Application Publication
(10) Pub. No.: US 2024/0228751 A1
(43) Pub. Date: Jul. 11, 2024

(54) Composite materials and articles produced from used clothing and polymer resin

(71) Applicant: Equilisyn LLC, Berkeley, CA (US)

(72) Inventors: Robert Fleming, San Jose, CA (US); Ethan Escowitz, Berkeley, CA (US)

(21) Appl. No.: 18/404,875

(22) Filed: Jan. 4, 2024

Related U.S. Application Data
(60) Provisional application No. 63/617,276, filed on Jan. 3, 2024.
(60) Provisional application No. 63/437,306, filed on Jan. 5, 2023.

(51) Int. Cl. C08K 11/00

(52) U.S. Cl. CPC C08K 11/005

(57) ABSTRACT

Methods for manufacturing durable goods from used textiles, and the articles made according to the methods, are provided. In an exemplary method used textiles are obtained, sorted, washed and dried. The used textiles are cut into suitable pieces, or joined into larger sections then cut into suitable pieces, then combined with a suitable resin in a mold. The resin is then cured. Curing can be photoinitiated by exposure to a suitable type of radiation, or thermally initiated by heating. At least some of the mold can be transparent to the suitable radiation where the curing is photoinitiated.

### CROSS-REFERENCE TO RELATED APPLICATIONS

This application claims the benefit of U.S. Provisional Patent Application No. 63/437,306 filed on Jan. 5, 2023 and entitled “Composite Materials and Articles Produced from Used Clothing and Polymer Resin,” the disclosure of which is incorporated herein by reference. This application also claims the benefit of U.S. Provisional Patent Application No. 63/826,518 filed on Jan. 3, 2024 and entitled “Composite Materials and Articles Produced from Waste Textile, Natural Fibers, and Polymer Resin,” the disclosure of which is incorporated herein by reference.

### BACKGROUND OF THE INVENTION

### Field of the Invention

The invention relates generally to the field of repurposing waste materials, and more particularly to manufacturing durable goods from waste textiles.

### Description of the Prior Art

Approximately 6% of all waste generated in the United States is comprised of used clothing, about 16 million tons annually. Discarded clothing typically is turned into rags, recycled, or enters the waste stream. The vast majority, 85% of all discarded clothing, is directed either to landfills or incineration.

A very small proportion of discarded clothing, less than 1%, is reprocessed to make use of the fibers. One reprocessing methodology involves melting, grinding, or pulverizing used clothing to a fine powder to be converted into a low-quality fiber, or to be used as a filler. Another reprocessing methodology involves chemically dissolving, breaking down, or thermally pyrolyzing the clothing to yield a raw chemical for chemical synthesis or fuel. Both of these methods are labor and energy intensive, leading to higher costs. Sorting and transporting the discarded clothing only adds to the costs.

Fiber reinforced polymer composites, or simply “composites” herein, are a class of materials that can offer advantageous properties to manufactured components such as a high strength to weight ratio, anisotropic properties such as stiffness in one direction and flexibility in another, corrosion resistance, chemical resistance, and unique shapes and surfaces. Composites include a fiber, to provide stiffness, disposed in a matrix of a polymer. Exemplary fibers comprise synthetic fibers, polymer fibers, carbon fibers, and glass fiber. The fibers are typically in the form of a filament, roving, woven fabric, or non-woven fabric and can be randomly oriented in the matrix, or directionally aligned in the matrix, and often are laminated with alternating fiber directions. The polymer matrix comprises a cured thermoplastic or thermosetting polymer resin, or “binder.” Composites are fabricated by mixing the fibers into the resin and then curing the mixture in a mold, or layering the resin between sheets of fibers in a mold, followed by curing.

Modern manufacturing of consumer goods and the like relies heavily on process controls, starting with the raw materials. In order to reliably produce uniform products of consistent quality, manufacturers seek to start with uniform starting materials, and then process the starting materials in precisely the same way, every time. Discarded clothing as a starting material is antithetical to modern manufacturing since it is a non-uniform mixture of different natural and synthetic fibers, that have been treated with different dyes, subjected to different detergents, body oils, and other contaminants. Thus, attempts to make use of discarded clothing and other textiles have sought to avoid these drawbacks by dissolving, breaking down, or pyrolyzing the fibers, reducing the fibers to a fine powder, or using the unwanted textiles as a filler.

### SUMMARY

An exemplary method of forming an article of manufacture comprises cutting a used textile into pieces, combining a piece of the used textile with a resin in a mold, and curing the resin to form the article. The method can also comprise obtaining mixed used textiles including the used textile, sorting the mixed used textiles, washing, and drying the used textile before cutting the used textile.

In various embodiments the mold comprises a UV transparent material and curing the resin includes exposing the resin to UV radiation through the mold. Curing can also comprise heating the mold. Combining the piece of the used textile with the resin in the mold can also include, in some embodiments, impregnating the piece with the resin before placing the piece in the mold. Alternately, combining the piece of the used textile with the resin in the mold includes placing the resin in the mold, then placing the piece in the mold, and then placing more resin in the mold. The resin can be a thermosetting or thermoplastic polymer, and the resin can further include a photoinitiator or a thermal initiator. In further embodiments the UV transmissivity of the used textiles is measured as part of the sorting process. Pieces of used textile can be stitched around the edges or joined to other pieces of used textile before being placed in the mold.

Articles of manufacture made by the methods of the present invention comprise a composite of a piece of a used textile within a cured resin.

### BRIEF DESCRIPTION OF DRAWINGS

FIG. 1 is a flowchart illustrating an exemplary method for producing articles according to an embodiment of the present invention.

FIG. 2 is photograph of an exemplary strip of denim cut from a pair of jeans according to an embodiment of the present invention.

FIG. 3 is a photograph of an exemplary belt made according to an embodiment of the present invention.

FIG. 4 is a photograph of an exemplary purse made according to an embodiment of the present invention.

### DETAILED DESCRIPTION

The present disclosure provides methods of efficiently turning used textiles into high value articles. When an article of clothing, such as a pair of jeans or shirt, has reached its end of life, it can be cut into shapes or strips suitable for a desired finished article, these pieces are then placed into a mold, individually or in overlapping stacks and patterns, along with a resin, and then cured. The result is a 3 dimensionally shaped composite product or article that can be bonded, sewn, stitched, or fastened into a finished item such as a belt, purse, backpack, hat, shoe, boot, waterproof bag, furniture, shelves, bicycle, vehicle, composite panel or the like.

As used herein, a used textile is one that was produced for another purpose, and employed for the other purpose. Used textiles expressly excludes manufactured textiles that have not been previously used. Used textiles are morphologically distinguishable from freshly manufactured textiles in that the fibers can be frayed and modified by exposure to various environments resulting in surface modifications such as bleaching from sunlight, exposure to chlorine, and so forth.

In this invention used textiles can comprise discarded clothing such as jeans, pants, shirts, jackets, skirts, dresses, and the like. The used textiles can also be from linens, bed sheets, blankets, or drapery. The fibers of the used textiles can be cotton, silk, wool, coir, kenaf, hemp, flax, bamboo, banana, protein, cellulose, nylon, polyester, acrylic, polyolefin, polyurethane, spandex and blends thereof, and can be either woven or nonwoven, though woven is preferred in some embodiments. The resin used to bind the fibers into the desired final shape can be thermosetting polymers, for example of the epoxy, acrylate, vinyl ester, or polyurethane type; or thermoplastic, for example of the polyamide, polylactic acid, polyurethane, or polyester type.

Combining a thermoplastic or thermosetting resin with a natural or synthetic fiber in the form of a woven or non-woven pristine textiles are well known in the art. It is also well known that the wetting, penetration, and adhesion of the resin to the fibers is critical to final performance. It is a surprising result that used textiles that have been worn and washed display surprisingly good wetting and adhesion to certain resins, most likely because the mechanical and chemical action of washing and wearing loosens the fiber bundles and the surfaces of the fibers are activated for wetting and bonding with the resin. When cost and performance are considered together used textile composites offer excellent advantages.

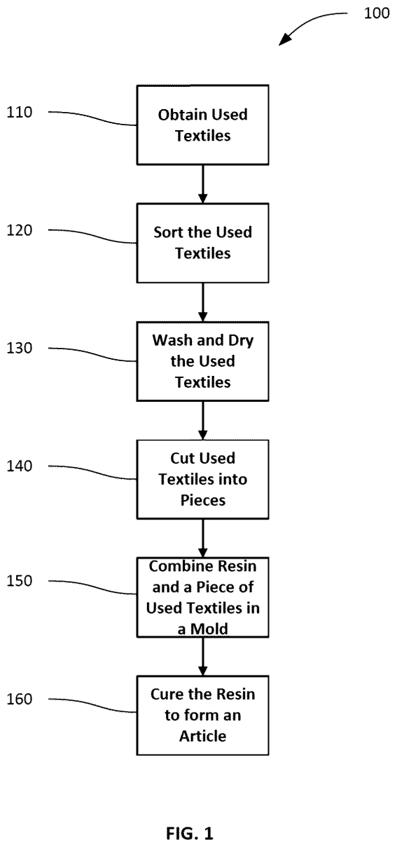

FIG. 1 illustrates an exemplary method 100 for producing articles of manufacture according to the present invention. The method 100 comprises the steps of obtaining used textiles 110, sorting the used textiles 120, washing and drying the used textiles 130, cutting the used textiles into pieces 140, combining a piece cut from the used textiles with a resin in a mold 150, and curing the resin to form the article 160. In various embodiments, any or all of the first three steps 110, 120, and 130 are optional.

Method 100 can be used to incorporate used textiles into articles of manufacture such as purses, hats, shoes, boots, backpacks, waist packs, wallets, cell phone covers, eyeglass cases, book covers, raincoats, luggage, sporting good equipment, furniture, bookshelves, vehicle parts, composite panels, etc. The method 100 does not require the extra step of shredding, grinding, milling, dissolving, or breaking down the fiber which requires added cost and energy, and also damages the structural integrity of the fibers. In such prior art methods, end materials may have a tensile strength ten times lower than the original material resulting in significantly lower performance at the expense of a greater amount of energy consumed.

The resin can be supplied into the mold as a melted liquid thermoplastic, or as a liquid thermosetting material. Preferably the resin used is comprised substantially from bio-based sources. After the resin is cured in the mold the article is removed. The article can be further modified by sewing, stitching, gluing, or bonding to attach, for example, buckles, buttons, zippers, to yield a finished item.

Exemplary resins can include meltable thermoplastics such as Nylon 6, polyethylene terephthalate (PET), polylactic acid (PLA), and polyurethane. The resin can also be cross-linkable such as acrylates, epoxies, urethanes, silanes, silicones, unsaturated polyesters, and vinyl compounds. These thermoplastic or cross-linkable resins can be partially or substantially derived from biobased sources such as agricultural crops or from fermented sources. Exemplary UV curable resins include a broad range of UV curable acrylates, such as from Arkema Sartomer, for example urethane acrylates such as CN975, CN3211, CN1964, CN9024. Exemplary UV curable resins can also include epoxy acrylate resins such as CN120, CN2602, or SR349, polyester acrylates such as CN2102E, CN973J5, aliphatic multifunctional acrylate resins such as SR351, SR9020, SR238, SR399, SR494, bio-based UV curable resins under the Sarbio name from Arkema Sartomer such as Sarbio 7205, 7107, 7106, 6102, 6101, 5106, 5102, 5201, 5103, and 5100. Allnex also supplies suitable commercial UV curable resins under the tradename Ebecryl, for example polyester based acrylates such as Ebercryl 876, 853, 892, 109, 110, 113 and 114, and urethane acrylates such as Ebercryl 1258, 1271, 1290, 1291. Allnex also supplies suitable biobased resins that could be used such as Ebecryl 5850, 5849, 5848, 767, 242, 4491, 4683, R1872, and IBOA. IGM Resins supplies suitable urethane acrylate resins under the Photomer tradename such a Photomer 6008, 6010, 6024, 6578, polyester acrylates, epoxy acrylates, and a line of biobased resins under the name PureOmer for example PureOmer 5433, 5437, 5443, 5450, 5662, 5850.

Unsaturated polyester or vinyl ester resins can also be employed, CN154 by Sartomer is a suitable vinylester methacrylate resin. Vinyl ester resins can be of the epoxy vinyl ester type, orthphthalic polyester type, or vinylpolyester type for example as supplied by AOCResins, the INEOS Group, or Interplast Corporation. INEOS Composites also supplies a suitable unsaturated polyester resin containing biobased materials. The resins can be cured by the photoinitiators and/or thermal initiators as described below. Cationic photoinitiators can also be employed. Epoxy resins amine, anhydride or photocationically cured resins can also be used. For instance, bisphenol A epoxy such as Epon 828 as supplied by Hexion can be cured with a Versamid supplied by Huntsman Corporation. A range of Epoxy resins and curing agents can be supplied by Huntsman Corporation, Hexion, DowDuPont, or Olin, for example. Epoxies used can also be obtained from biobased sources such as epoxidized soybean oils.

Photoinitiators are added to UV curable resin to initiate polymerization, and suitable examples include Speedcure BPO, EMK, TPO, TPO-L supplied by Allnex. BASF supplies a range of suitable acrylate monomers and acrylate resins under the Laromer name, and also supplies suitable photoinitiators under the Irgacure tradename such as Irgacure 184, 819, and 907. IGM Resins supplies suitable photoinitiators under the Omnirad name such as Omnirad 184, 1173, 127, 1000, ITX, EMK, MBF, OMBB. In addition to, or in place of, the photoinitiator a thermal initiator can be employed that generates a free radical by thermal decomposition. Akzo makes a line of suitable thermal initiators of many types such as the ketone peroxide type like Butanox M-50 or the diacyl peroxide type like Perkadox GB50L or Perkadox L40, Peroxyesters, or azobisisobutylnitrile. Also, catalysts under the Nouryact name by Akzo can be used.

The mold can be made of metal, plastic, glass, ceramic, or combinations thereof. Low-cost acrylic molds are preferred in some embodiments. UV transparency is desirable for molds intended for use in combination with UV curable resins. Metal molds are suitable for heat conduction for use with thermally cured resins.

In step 110 used textiles are obtained. The used textiles can be obtained from a wide range of sources, for example organizations such as GoodWill that collect used clothing. Where the used textiles that are obtained in step 110 are a mixture of different articles, the used textiles can be sorted in step 120, such as by material type, color, pattern, and by size, for example. The material type can be determined from affixed tags or labels, or by measured physical properties of the used textiles, or by chemical analysis methods such as infrared spectroscopy. The resin formulation chosen as a binder may differ depending on the type of fabric as the composition of the fabric can affect adhesion and curing. The color and patterning of the fabric can impact the aesthetics of the finished article and in some embodiments will also influence the curing method and conditions. For instance, darker dyed fabrics may require a different formulation and curing condition (i.e. UV curing) than a lightly colored fabric. It may be desirable to measure the UV transmissivity of the used textiles as part of sorting in step 120.

In step 130 the used textiles are washed and dried. This can serve to remove oils and dirt that could negatively affect adhesion. Drying removes moisture that can also negatively affect adhesion and curing. Step 130 can take place before step 120, in some embodiments.

In step 140 the used textiles are cut, or otherwise sectioned, to a desired shape. Cutting can be performed, for instance, by die cutting to repeatedly cut the same shape from the used textiles. In some embodiments the pieces cut from the used textiles have the same shape as a footprint of the mold into which they will be placed.

Additionally in step 140, once the fabric is cut into its desired shape, it may be advantageous to add stitching for cosmetic reasons but also for functional reasons such as to control sharply defined edges for better molding and to prevent fraying. In some embodiments, it may be desired to join, such as by stitching or bonding, the cut fabric sections together prior to cutting into pieces, such as to create a long continuous length that can be rolled up for more efficient processing (i.e. coating or molding). In other cases, it may be desirable to join the cut fabric sections together to be cut into shapes larger than the original pieces of used textile, or to impart differing material properties to different regions of the finished article, and/or differing aesthetics in different regions of the finished article.

In step 150 pieces cut from the used textiles are combined with a resin in a mold. In an exemplary process resin is added to the bottom of the mold cavity, a piece cut from used textile is added next to the mold cavity, and then additional resin is added to the mold cavity. It will be appreciated that multiple layers of pieces cut from used textiles can be laminated, optionally with alternating additions of the resin. Air bubbles can be squeezed from the mold cavity by placing the top on the mold, or otherwise assembling the mold, and squeezing the mold, or by inserting the mold into a chamber or bag and applying vacuum. Ports can be added to the mold to both add additional resin and to apply a vacuum to degas and remove air bubbles.

In other embodiments the cut piece of used textile can impregnated with resin before being placed in the mold cavity. For instance, the cut piece of used textile can be submerged in the resin to impregnate the fabric. This is particularly advantageous where the cut pieces of used textile are stitched together into long lengths that can be passed through the resin, molded, and cured in a continuous or semi-continuous manner.

In step 160 the resin in the mold cavity is cured to form the article. Resin distribution within the mold and relative to the pieces of used textiles ensures desired wet-out and impregnation of the fibers and the desired cosmetic and functional attributes. The resin can be cured in the mold by applying heat, by applying radiation such as UV (Ultraviolet) or IR (infrared) radiation or by applying a combination of heat, and/or UV, and/or IR. If the resin is a thermoplastic, then the molten resin will be combined with the fabric in the mold then cooled to solidify.

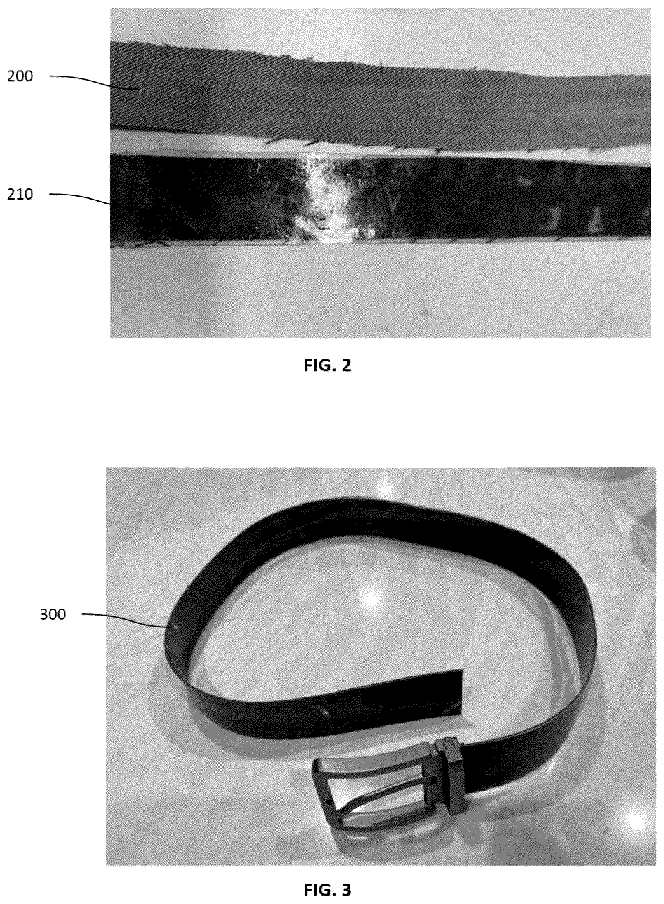

FIG. 2 is a photograph of a 1.25″×36″ strip of denim 200 cut from used denim jeans. The strip of denim 200 and a UV curable resin were placed in a UV transparent mold made of Plexiglass acrylic, exposed to UV radiation while in the mold to cure the resin, and then the article 210 was removed. After trimming the edges of the article 210, a buckle was attached to the end of the article 210 to produce a belt 300 as shown in the photograph of FIG. 3.

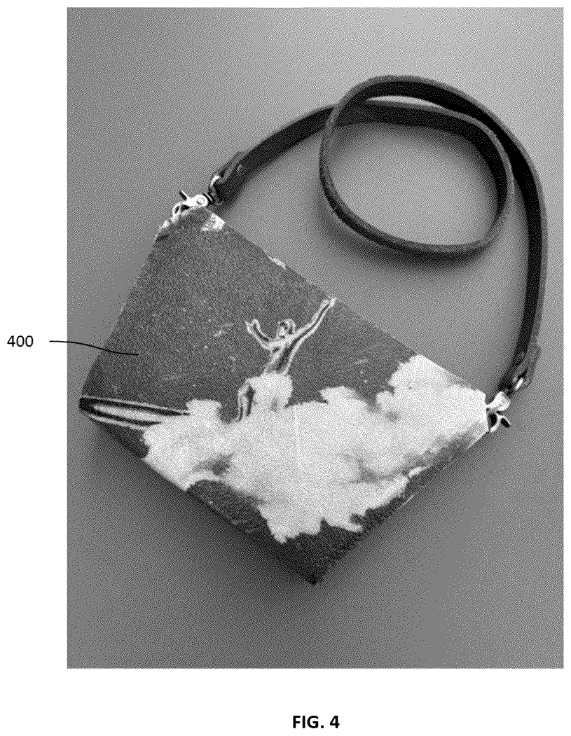

FIG. 4 is a photograph of a purse 400 created according to an exemplary embodiment of the present invention. In this example a Plexiglas acrylic sheet was shaped into an inner mold, and a textured Plexiglas acrylic sheet was shaped into an outer mold in order to create the purse 400. A used Hawaiian style shirt was cut into a shape that would fit into the mold. A UV curable resin was coated onto the surface of the inner mold, the piece of the Hawaiian fabric was placed over the resin and pressed down into it so the resin completely wetted and penetrated the fabric. A layer of resin was then coated on top of the Hawaiian fabric, the outer mold was applied to the resin coated fabric on the inner mold and the inner mold and outer molds we squeezed with pressure to eliminate air bubbles and to get complete wetting of the resin into the fabric and complete wetting on the mold surfaces. The part was then UV cured with an Omnicure 2000 UV curing apparatus. After curing the fabric composite was removed from the mold, and assembled into the complete purse 400 by attaching a strap.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of forming an article of manufacture, comprising:
cutting a used textile into pieces;
combining a piece of the used textile with a resin in a mold; and
curing the resin to form the article.

2. The method of claim 1 wherein the mold comprises a UV transparent material and curing the resin includes exposing the resin to UV radiation through the mold.

3. The method of claim 1 further comprising washing and drying the used textile before cutting the used textile.

4. The method of claim 1 wherein combining the piece of the used textile with the resin in the mold includes impregnating the piece with the resin before placing the piece in the mold.

5. The method of claim 1 wherein combining the piece of the used textile with the resin in the mold includes placing the resin in the mold, then placing the piece in the mold, and then placing more resin in the mold.

6. The method of claim 1 wherein the resin is a thermosetting or thermoplastic polymer.

7. The method of claim 1 wherein the resin includes a photoinitiator.

8. The method of claim 1 wherein the resin includes a thermal initiator.

9. The method of claim 1 further comprising obtaining mixed used textiles including the used textile, and sorting the mixed used textiles.

10. The method of claim 9 further comprising measuring the UV transmissivity of the used textiles.

11. The method of claim 9 further comprising washing and drying the used textiles.

12. The method of claim 1 further comprising stitching the piece of the used textile before combining the piece of the used textile with the resin in the mold.

13. The method of claim 1 further comprising heating the piece of the used textile with the resin in the mold.

14. The method of claim 1 wherein combining the piece of the used textile with the resin in the mold further comprises combining a second piece of a textile in the mold with the piece of used textile and the resin, such that the piece of the used textile and the second piece are layered.

15. The method of claim 14 wherein the second piece is of a textile that is not a used textile.

16. The method of claim 15 wherein the second piece is of a glass, carbon fiber, or synthetic fiber textile.

17. An article of manufacture comprising:
a composite of a piece of a used textile within a cured resin.
